(19) United States
(12) Patent Application Publication
(10) Pub. No.: US 2004/0093250 A1
(43) Pub. Date: May 13, 2004

(54) Kitchen order system

(75) Inventor: Hiroyasu Hasegawa, Kanagawa (JP)

Correspondence Address: FOLEY AND LARDNER, SUITE 500, 3000 K STREET NW, WASHINGTON, DC, 20007, US

(73) Assignee: NEC Infrontia Corporation

(21) Appl. No.: 10/701,518

(22) Filed: Nov. 6, 2003

(30) Foreign Application Priority Data
Nov. 7, 2002 (JP) 2002-323565

(51) Int. Cl. G06F 17/60

(52) U.S. Cl. 705/7

(57) ABSTRACT

A CPU 2, a ROM 3, a RAM 4 and an input/display part 5 are connected to a POS main unit 1. A communication part 6 is connected to the CPU 2 for transmitting and receiving data to and from a handy terminal 10 and a kitchen 17. In a main cooking menu 7, data of main cooking names are collectively stored. In a sub-cooking menu 8, three different cooking forms, i.e., “increase”, “deletion” and “addition” are described for each sub-cooking name. A check table 9 is provided as a data check table for checking whether a combination of one of a plurality of main cooking names of the main cooking menu 7 and one of a plurality of sub-cooking names of the sub-cooking menu 8 is proper.

### BACKGROUND OF THE INVENTION

This application claims benefit of Japanese Patent Application No. 2002-323565 filed on Nov. 7, 2002, the contents of which are incorporated by the reference.

The present invention relates to kitchen order systems and, more particularly, to kitchen order systems capable of transferring cooking item data as a combination of a selected main cooking name in a main cooking menu and a selected sub-cooking name in a sub-cooking menu to a kitchen.

In family restaurants, hamburger shops and like restaurants, usually an operator receives a cooking order by using a handy terminal, and transmits the order contents in the form of a print slip to a cock in a kitchen or issues a cooking start command to the cook by causing the display of the order contents on a display provided in the kitchen to let the cook begin cooking according to the order contents instruction (see Japanese patent laid-open No.Hei 11-045300, for instance).

The order contents received by the operator include main cooking name and sub-cooking name subordinate thereto. Further, when, for instance, the main coking name is hamburger and the basic conditions are “presence of lettuce” and “presence of mayonnaise”, the sub-cooking menu permits selection of “increase tomato”, “no tomato”, “increase lettuce”, “no lettuce”, “increase mayonnaise”, “no mayonnaise”, etc. so as to be able to meet the tastes of many customers. In many case, these order contents are handled by using a handy terminal carried by the operator.

The handy terminal has a component, which can execute a function of transferring, to the kitchen, cooking item data representing a combination of a main cooking name selected from the main cooking menu, which is a list display of a plurality of main cooking names, and a sub-cooking name selected from the sub-cooking menu, which is a list display of a plurality of sub-cooking names (disclosed in, for instance, Japanese patent Laid-open No. Hei 10-11194).

In the prior art kitchen order system, the operator can receive orders from customers and real-time transfer of the order contents to cooks in the kitchen, so that it permits carrying our efficient restraint business. However, when a sub-cooking name which can not be combined with a main cooking name is selected at the time of acceptance of a customer's order by the operator, a problem arises that various confusions are caused to a cook who actually does in the kitchen side.

This problem in the kitchen will now be described in detail in connection with a case taken as an example of an item selected among a main cooking menu as the main cooking name is hamburger.

Assuming now that the item of a hamburger consists of a five constituent elements of buns, pate, tomato, lettuce and pickles, when an operator registers the hamburger according to a customer's order, a slip with printed letters of “hamburger” is outputted, and the letters “hamburger” are displayed on a display provided in the kitchen.

Observing the display, a cook starts the cooking of the hamburger. At this time, since the cook has obtained from a manual or the like an intelligence that the item of hamburger is constituted by the five constituent elements, he or she can immediately begins the cooking.

At this time, a sub-cooking name is instructed to the cook, and the cook makes sub-cooking with respect to the eventual hamburger, the cooking of which has begun. The sub-cooking is made as one of a plurality of different forms, for instance three different forms of volume increase, deletion and addition. The form of increase is to increase the quantity of one of the constituent elements of the main cooking name, for instance increase the quantity of tomato. The form deletion is to delete one or more standard constituent elements, for instance delete tomato. The form of addition is to add what is other than the constituent elements of the main cooking name, for instance add mayonnaise.

Among the customers are those who like mayonnaise, and some customers order a hamburger with mayonnaise. In this case, after the operator has inputted the item of a hamburger, he or she registers “add mayonnaise” as a sub-cooking name with respect to the hamburger. By so doing, the cook can immediately and efficiently cook a hamburger with mayonnaise.

However, if the operator erroneously inputs an instruction of “increase mayonnaise” as sub-cooking name in spite of the fact that the customer has ordered a hamburger with mayonnaise, a cooking instruction is sent to the cook in the kitchen to increase the quantity of mayonnaise, which must not be a constituent element of the hamburger, thus causing confusion of the cook. That is, the cook can not make a decision as to whether a hamburger with mayonnaise is to be cooked or the hamburger is an erroneous input, or whether “increase mayonnaise” is an erroneous input, so that he or she can not begin cooking. Consequently, the cook may make an inquiry to the operator who has made the input, or may complete cooking by his or her own decision to unfortunately result in production of an erroneous item. At any rate, the efficiency of a series of businesses is extremely deteriorated.

### SUMMARY OF THE INVENTION

Accordingly, the present invention has an object of providing a kitchen order system, which prohibit input of an improper item name as sub-cooking menu or informs an erroneous input, if any, during the operator's input of an item name to be sent out to the kitchen, thus improving the item registration operation control property and preventing confusion in the kitchen site.

According to an aspect of the present invention, there is provided a kitchen order system capable of transferring, to a kitchen, cooking item data representing a combination of a main cooking name selected from a main cooking menu and a sub-cooking name selected among a sub-cooking menu, wherein: a data check table is provided for checking whether a combination of each of a plurality of main cooking names of the main cooking menu and each of a plurality of sub-cooking names of the sub-cooking menu is proper; and when a sub-cooking name is inputted simultaneously with the input of the main cooking name, the input of the sub-cooking name is checked with reference to the data check table for executing, if the input is not proper, a notification that the inputted sub-cooking name is an input error.

According another aspect of the present invention, there is provided a kitchen order system capable of transferring, to a kitchen, cooking item data representing a combination of a main cooking name selected from a main cooking menu and a sub-cooking name selected among a sub-cooking menu, wherein: a data check table is provided for checking whether a combination of each of a plurality of main cooking names of the main cooking menu and each of a plurality of sub-cooking names of the sub-cooking menu is proper; and when a main cooking name is inputted, a sub-cooking name properly corresponding to the inputted main cooking name is taken out from the data check table for selecting the sole taken-out sub-cooking name as the sub-cooking menu

The data of the main cooking menu and the sub-cooking menu are stored in a handy terminal for inputting a cooking item name to transfer cooking item data thereof to the kitchen.

The data of the main cooking menu and the sub-cooking menu are stored in an external database and obtained from a handy terminal, which is provided for inputting a cooking item name, by communicating the external database for transferring cooking item data to the kitchen.

The kitchen order system further comprises an additional report forming part for statistically collecting the frequencies of transfer of the main cooking menu and the sub-cooking menu to the kitchen.

The report forming part is provided in the handy terminal or in the external database.

Other objects and features will be clarified from the following description with reference to attached drawings.

### BRIEF DESCRIPTION OF THE DRAWINGS

FIG. 1 shows an overall arrangement of the kitchen order system using the kitchen order item input management unit according to the present invention;

FIG. 2 schematically shows the data contents stored in the main cooking menu 7 in FIG. 1;

FIG. 3 schematically shows the data contents stored in the sub-cooking menu 8 in FIG. 1;

FIG. 4 schematically shows the data contents stored in the check table 9 in FIG. 1; and

FIG. 5 is a flowchart showing main operation of the kitchen order system according to the present invention.

### PREFERRED EMBODIMENTS OF THE INVENTION

Preferred embodiments of the present invention will now be described with reference to the drawings.

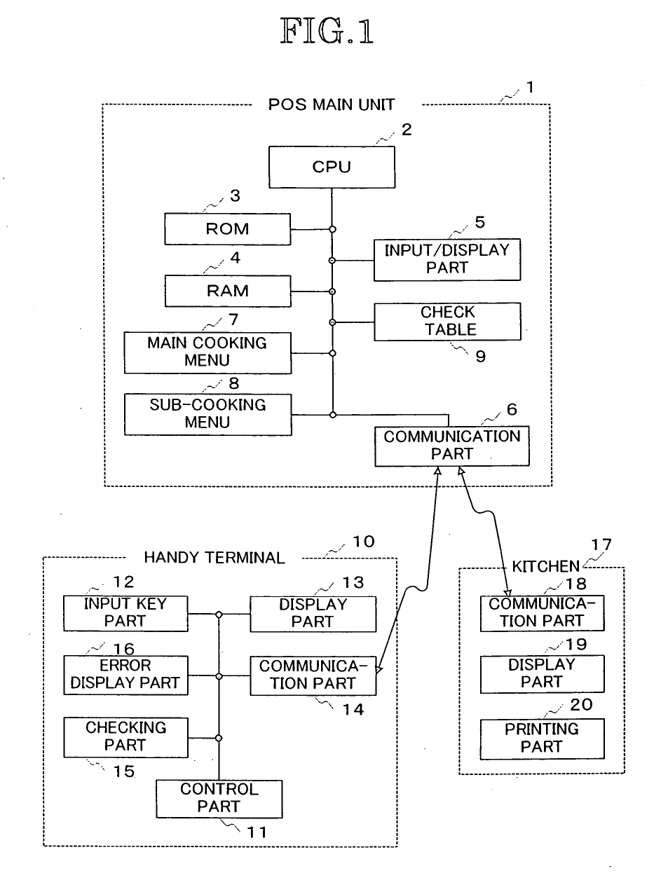

First, the overall arrangement of the kitchen order system will be described with reference to FIG. 1. A POS main unit 1 which is a system element compositely controls a series of businesses in a restaurant. In the POS main unit 1, a ROM 3 for storing predetermined program data, a RAM 4 used for transiently reading out from and written in for a series of data processes, and an input/display part 5 for inputting operation commands and displaying various data, are connected to a CPU 2 for controlling the entire unit. The POS main unit 1 further includes a communication part 6 connected to the CPU 2 for transmitting and receiving data to and form a handy terminal and a kitchen 17.

In the kitchen order system having the above basic arrangement, the POS main unit 1 further includes a main cooking menu 7, a sub-cooking menu 8 and a check table 9, these components being connected to the CPU 2.

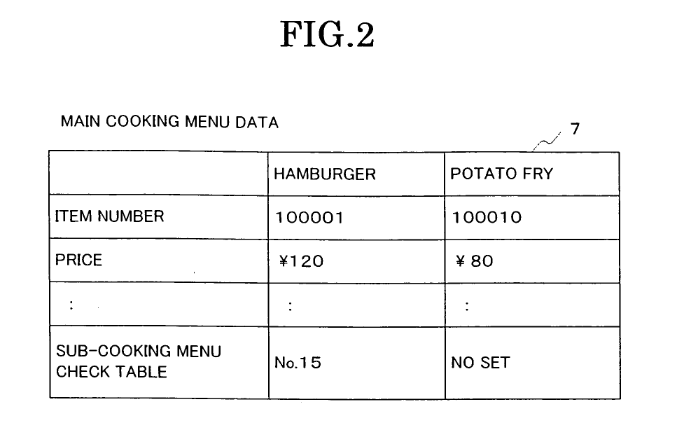

FIG. 2 schematically shows the data contents stored in the main cooking menu 7. As shown, as main cooking names, “hamburger”, “potato fry”, . . . , for instance, are collectively stored. For these main cooking names, item numbers and prices are stored. Furthermore, for these entries numbers of sub-cooking menu check tables are stored, and in the no sub-cooking case, this content is described as such.

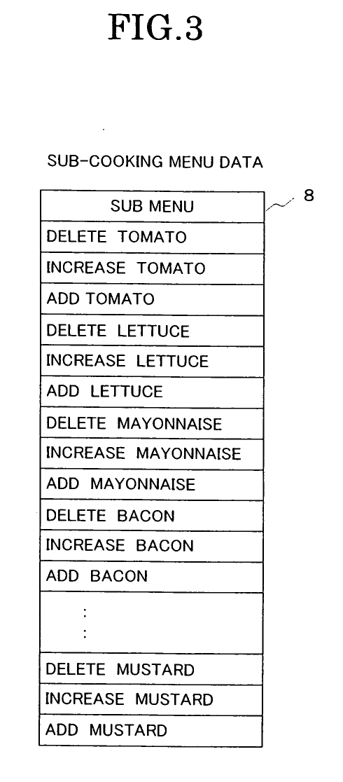

FIG. 3 schematically shows the sub-cooking menu 8. As shown, for each of the sub-cooking names, such as tomato, lettuce and mayonnaise, three different cooking frames of increase, deletion and addition are described. All the sub-cooking names for each of the plurality of main cooking names in the main cooking menu 7 are described. As for the increase, the deletion and the addition, as described before, the term “increase” means increasing the quantity of one of the constituent elements of the main cooking name, the term “deletion” means deleting more or more standard constituent elements, and the term “addition” means adding what is other than the constituent elements of the main cooking name.

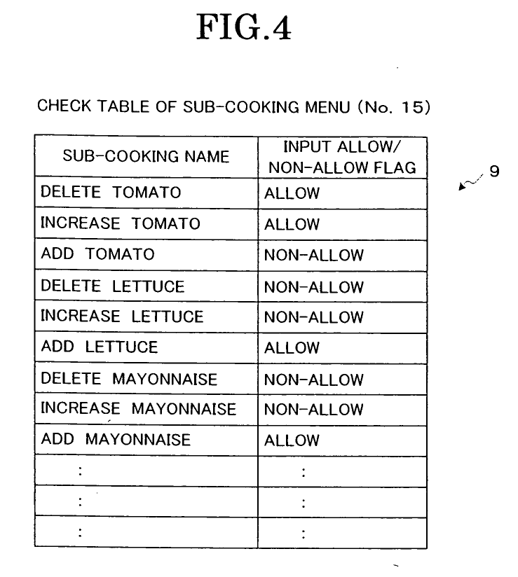

The check table 9 is a data check table for checking whether the combination of each of the plurality of main cooking names in the main cooking menu 7 and each of the plurality of sub-cooking names in the sub-cooking menu 8 is proper. As schematically shown in FIG. 4, for instance, in the check table 9 the sub-cooking names and input allow/non-allow flag states corresponding thereto are described. As the check table 9, a plurality of tables are prepared in number corresponding to the number of all the main cooking names, that is one check table is prepared for each main cooking name, for instance a table No. 15 is provided for hamburger as main cooking name.

The handy terminal 10 is provided for data communication via the communication part 6 in the POS main unit 1 of the above arrangement, and is to be carried by the operator for inputting the main cooking name and sub-cooking name of a customers ordered cooking item. The handy terminal 10 includes a control part 11 for compositely controlling its entirety.

In the handy terminal 10, an input key part 12 for inputting main cooking names and sub-cooking names, a display part 13 for displaying the main cooking menu and the sub-cooking menu as table displays, and a communication part 14 for causing data communication with the POS main unit 1 are connected to a control part 11.

The handy terminal 10 further includes a checking part and an error display part 16, these parts being also connected to the control part 11. When the checking part 15 receives a sub-cooking name simultaneously with the main cooking name input, it checks the inputted sub-cooking name based on the contents in the check table 9 in the POS main unit 1. When the check part 15 could not have decided that the inputted sub-cooking name is proper, the error display part 16 notifies that the inputted sub-cooking name is an input error.

Via the communication part 6 in the POS main unit 1 receiving data from the handy terminal 10 having the above arrangement, the main cooking name data and the sub-cooking name data are transferred to the kitchen 17.

The kitchen 17 includes communication part 18 for performing communication with the communication part 6 in the POS main unit 1, a display part 19 for displaying a cooking beginning command on the basis of a main cooking name and sub-cooking name outputted from the handy terminal 10, and a printing part 20 for informing the pertinent cooking name printed in a slip to a cook.

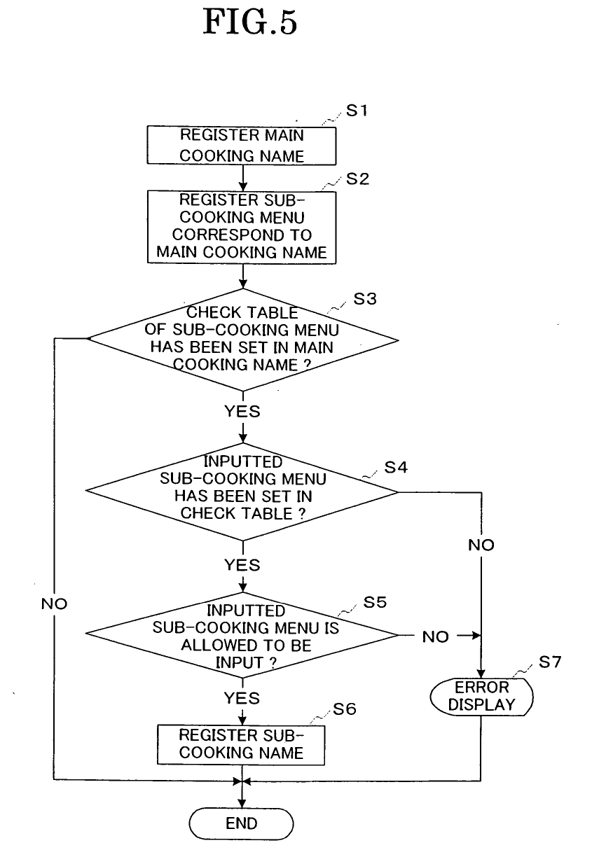

FIG. 5 is a flow chart illustrating the routine of kitchen order item input management operation. First, in a step S1 a main cooking name is registered in the main cooking menu 7. In a next step S2 registration of a sub-cooking menu 8 corresponding to the main cooking name is registered. In a next step S3, a check as to whether a check table 9 corresponding to the main cooking name has been set is made. When the check table 9 has been set (i.e., in the case of “Yes”), a next step S4 is executed. When no check table 9 has been set (i.e., in the case of “No”), an end is brought to the routine.

In the step S4, a check is made as to whether a sub-cooking menu corresponding to the main cooking name inputted to the handy terminal 10 is present in the check table 9. When the sub-cooking menu is present (i.e., in the case of “Yes”), a step S5 is executed, in which a check is made as to whether it is possible to input the sub-cooking menu inputted by the handy terminal 10.

When it is decided in the step S5 that it is possible to input (i.e., in the case of “Yes”), a next step S6 is executed, in which the sub-cooking name is registered, thus bringing an end to the routine.

In the case of “No” in either one of the steps S4 and S5, a step S7 is executed, in which the error display part 16 executes error display, i.e., performs notification on the basis of the check in the checking part 15, thus bringing an end to the routine while arousing the operator's caution.

As a specific example of operation in the above embodiment, in the case of registering the main cooking name of hamburger as selected from the main cooking menu 7 and then registering the mayonnaise increase data in the sub-cooking menu 8 corresponding to the hamburger, since table No. 15 is set as the check table 9 for the hamburger, the contents of this table are checked.

Since it is deemed to be impossible to perform the mayonnaise increase as set in the table No. 15 as the check table 9, it is decided that the input is erroneous, and it is made impossible to register the mayonnaise increase.

As a different example, in the case of registering the main cooking name of hamburger as selected from the main cooking menu 7 and registering tomato deletion data in the sub-cooking menu 8 corresponding to the hamburger, since table No. 15 (see FIG. 4) is set as the check table 9, the contents of this table are checked.

Since it is made impossible to perform the tomato deletion as set in the table No. 15 as the check table 9, the input data is transmitted to the POS main unit 1. The POS main unit 1 thus transfers to the kitchen 17 that the main cooking name is hamburger and the sub-cooking name is tomato deletion, and a cooking instruction to the cook is made with the use of the display part 19 and the printing part 20.

As a further example, in the case of registering the main cooking name of fried potato as selected from the main cooking menu 7 and registering the beacon addition data in the sub-cooking menu 8 corresponding to the fried potato, since no particular table is set as the check table 9 corresponding to the fried potato, the beacon addition is registered. While in this example a sub-cooking menu of beacon addition is registered for the fried potato, by setting an adequate sub-cooking menu check table for fried potato, it is possible to prevent the registration of the sub-cooking name of beacon addition.

In the embodiment described so far, the contents in the main cooking menu 7 and in the sub-cooking menu 8 are all displayed, and notification as to whether the inputted combination is appropriate is made irrespective of whether the combination is possible or not. As an alternative, it is possible to arrange such as to permit, when a main cooking name is inputted, taking out a sub-cooking name properly corresponding to that main cooking name from the data check table and selecting the sole taken-out sub-cooking name as sub-cooking menu. In this case, since it is prohibited to input any cooking name which is incapable of being combined, it is possible to make efficient registration without redundant input operation.

Also, while the data of the main cooking menu 7 and the sub-cooking menu 8 are provided in the POS main unit 1, or the transmission of cooking item data to the kitchen it is possible to store these data in the handy terminal, to which item names are inputted. As a further alternative, these data may be stored in an external database, and the handy terminal, to which item names are inputted, may obtain cooking item data by doing communication with the external database for transferring the obtained data to the kitchen.

Furthermore, it is of course possible to provide the POS main unit 1 with an additional report forming part for statistically collecting the frequencies of transfer of the main cooking menu and the sub-cooking menu to the kitchen and also provide such report forming part in the handy terminal 10 or the external database.

As has bee made obvious from the foregoing, with the kitchen order system according to the present invention it is possible to prevent registration of an erroneous sub-cooking menu, thus ensuring the freedom from efficiency reduction of the operators registering operation. Also, since no erroneous sub-cooking menu data is sent out to the kitchen, it is possible to preclude confusion in the kitchen and operation efficiency reduction. Furthermore, as for the production of various reports, since summation with erroneous sub-cooking menu registration is eliminated, it is possible to obtain accurate reports.

According to the present invention, it is thus possible to provide a kitchen order system capable of prohibiting input of an improper item name as sub-cooking menu or informs an erroneous input, if any, during the operator's input of an item name to be sent out to the kitchen, thus improving the item registration operation control property and preventing confusion in the kitchen site.

Changes in construction will occur to those skilled in the art and various apparently different modifications and embodiments may be made without departing from the scope of the present invention. The matter set forth in the foregoing description and accompanying drawings is offered by way of illustration only. It is therefore intended that the foregoing description be regarded as illustrative rather than limiting.

What is claimed is:

1. A kitchen order system capable of transferring, to a kitchen, cooking item data representing a combination of a main cooking name selected from a main cooking menu and a sub-cooking name selected among a sub-cooking menu, wherein:
a data check table is provided for checking whether a combination of each of a plurality of main cooking names of the main cooking menu and each of a plurality of sub-cooking names of the sub-cooking menu is proper; and
when a sub-cooking name is inputted simultaneously with the input of the main cooking name, the input of the sub-cooking name is checked with reference to the data check table for executing, if the input is not proper, a notification that the inputted sub-cooking name is an input error.

2. A kitchen order system capable of transferring, to a kitchen, cooking item data representing a combination of a main cooking name selected from a main cooking menu and a sub-cooking name selected among a sub-cooking menu, wherein:
a data check table is provided for checking whether a combination of each of a plurality of main cooking names of the main cooking menu and each of a plurality of sub-cooking names of the sub-cooking menu is proper; and
when a main cooking name is inputted, a sub-cooking name properly corresponding to the inputted main cooking name is taken out from the data check table for selecting the sole taken-out sub-cooking name as the sub-cooking menu.

3. The kitchen order system according to one of claims 1 and 2, wherein the data of the main cooking menu and the sub-cooking menu are stored in a handy terminal for inputting a cooking item name to transfer cooking item data thereof to the kitchen.

4. The kitchen order system according to one of claims 1 and 2, the data of the main cooking menu and the sub-cooking menu are stored in an external database and obtained from a handy terminal, which is provided for inputting a cooking item name, by communicating the external database for transferring cooking item data to the kitchen.

5. The kitchen order system according to one of claims 1 to 4, which further comprises an additional report forming part for statistically collecting the frequencies of transfer of the main cooking menu and the sub-cooking menu to the kitchen.

6. The kitchen order system according to claim 5, wherein the report forming part is provided in the handy terminal or in the external database.
